(19) United States
(12) Patent Application Publication
(10) Pub. No.: US 2021/0146755 A1
(43) Pub. Date: May 20, 2021

(54) CABIN HEATER FOR VEHICLE

(71) Applicant: LEXMARK INTERNATIONAL, INC., Lexington, KY (US)

(72) Inventors: PETER ALDEN BAYERLE, LEXINGTON, KY (US); JAMES DOUGLAS GILMORE, GEORGETOWN, KY (US); RUSSELL EDWARD LUCAS, LEXINGTON, KY (US)

(21) Appl. No.: 17/076,160

(22) Filed: Oct. 21, 2020

Related U.S. Application Data
(60) Provisional application No. 62/935,532, filed on Nov. 14, 2019.

(51) Int. Cl. B60H 1/22; H05B 3/14; F24H 3/04

(52) U.S. Cl. CPC B60H 1/2225; H05B 3/141; B60H 2001/2271; H05B 2203/02; H05B 2203/023; F24H 3/0429

(57) ABSTRACT

A cabin heater for a vehicle includes a frame with spaced apart longitudinal supports to locate a common electrical return and a power input. Pluralities of heating units extend between the supports and attach to the return and input. Each unit has a ceramic heater and one or more positive temperature coefficient (PTC) elements. The ceramic heater quickly and directly heats air and helps lower the inrush current of each PTC element upon initial powering. The power input also includes conductive rails spaced apart and electrically isolated from one another to individually supply power to either the ceramic heater or the PTC elements, but not both. Conductive extensions pass through the rails and fold into contact to power either the heater or the PTC elements. The electrical return commonly attaches the PTC elements and the heater, including a spring connection.

### FIELD OF THE INVENTION

The present disclosure relates to heating a passenger cabin for a vehicle, such as a battery-powered, hybrid, or plug-in electric vehicle. The disclosure relates further to a forced-air electric heater utilizing positive temperature coefficient (PTC) elements.

### BACKGROUND

As the automotive industry involves itself with electric vehicles to supplement or replace traditional vehicles running on fossil fuels, research is ongoing for the best practical application for heating passenger cabins. Popular heating sources include heat pumps and combustion heaters, but PTC heaters have emerged as better candidates owing to their heating efficiency, reliability, safety and heating capacity. In a traditional design, a PTC heater includes a series of PTC elements embedded in a radiator-type arrangement, i.e. an array of aluminum-finned heat spreaders attached to PTC heaters. Air flows through the aluminum fin heat spreaders—removing heat from the PTC. However, known drawbacks of PTC elements include their relatively slow heat time. Sometimes users of vehicles complain about relatively long times to reach desired heating temperatures in passenger cabins which is attributed to relatively high inrush of current upon initial powering. That is, PTC materials, when cold, have a severely low resistance thereby creating an extremely high inrush current. Developers then must be careful to avoid draining the battery of the vehicle or using excessive fuel when countering the inrush current. The inventors recognize a need to overcome these and other problems.

### SUMMARY

A cabin heater for a vehicle includes a frame with spaced apart longitudinal supports to locate a common electrical return and a power input. Pluralities of heating units extend between the supports and attach to the return and input. Each unit has a ceramic heater and one or more positive temperature coefficient (PTC) elements. The ceramic heater quickly and directly heats air and helps lower the inrush current of each PTC element upon initial powering. This allows for higher initial power.

The power input includes a plurality of conductive rails spaced apart and electrically isolated from one another to individually supply power to either the ceramic heater or the PTC elements, but not both. Conductive extensions pass through the conductive rails and fold into contact with one of the conductive rails to power either the heater or the PTC elements. Fasteners secure the extensions to the rails. The electrical return commonly attaches the PTC elements and the heater, including a spring connection in one embodiment.

Further longitudinal supports are added to the frame to support additional, adjacent heating units. This includes sharing the common electrical return and locating another power input for the additional units. A locator in the heating units adjusts an amount and pattern of PTC elements as needed for customization according to heating requirements of passenger cabins. A conductive shim and insulator are also arranged to improve heat transfer. Other embodiments are contemplated.

### BRIEF DESCRIPTION OF THE FIGURES

FIG. 1A is a diagrammatic view of a heater for a cabin, including a frame supporting a plurality of heating units;

FIG. 1B is a sectional view according to line A-A in FIG. 1A, including an enlarged view of detail in Circle B;

FIG. 2 is an exploded view of a frame, including an exploded view of a heating unit extending in the frame between a common electrical return and power input;

FIGS. 3A and 3B are diagrammatic views of a ceramic heater and one or more PTC elements and their associated conductive extensions for electrically connecting to the power input;

FIGS. 4A through 4F are sequential views for connecting the heater and PTC elements to respective conductive rails of the power input;

FIGS. 5A and 5B are diagrammatic views for connecting the heater and PTC elements to the common electrical return; and

FIG. 6 is an exploded view of a heater for a cabin including a frame having adjacent heating units sharing a common electrical return with multiple power inputs.

### DETAILED DESCRIPTION OF THE EMBODIMENTS

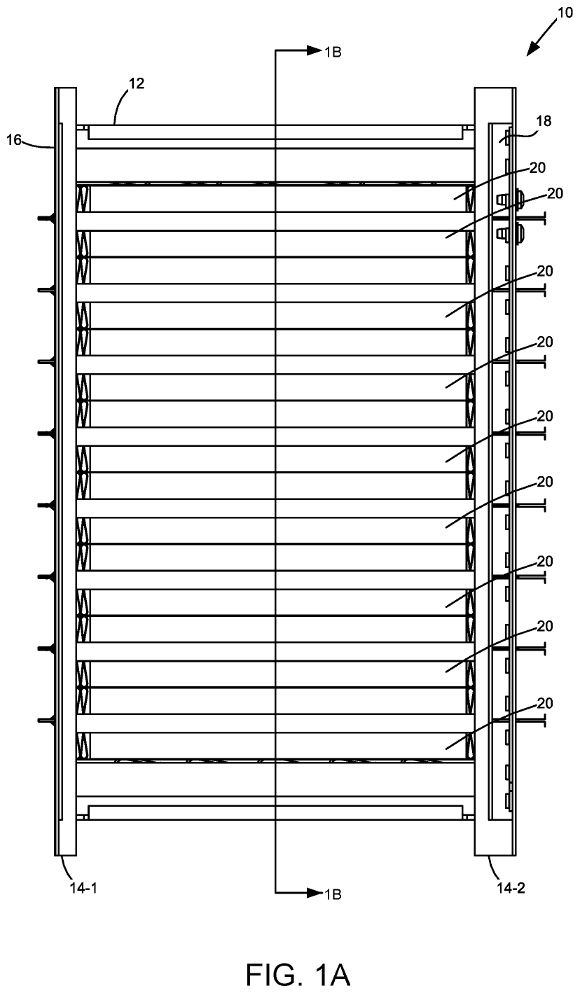

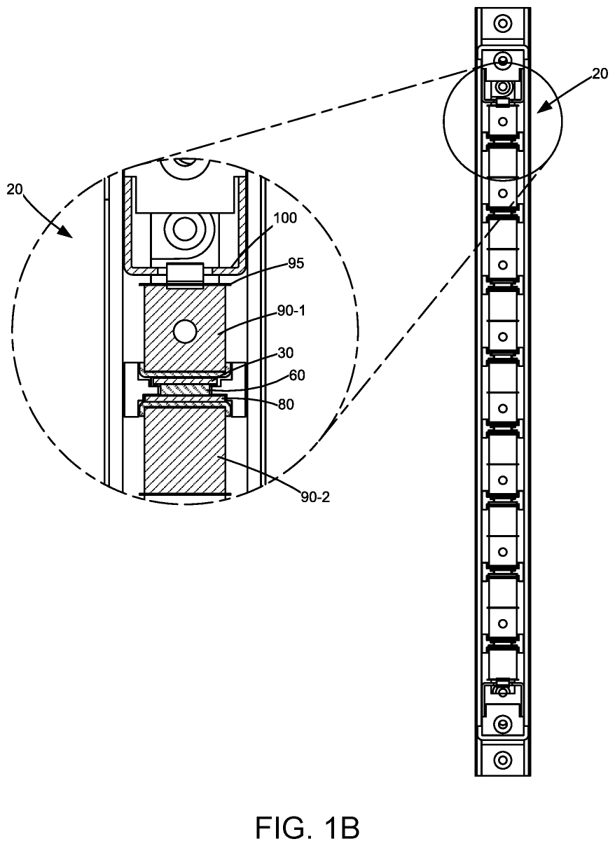

FIG. 1A teaches a cabin heater 10 for a vehicle. The heater includes a frame 12 with a plurality of spaced-apart longitudinal supports 14-1, 14-2. A plurality of heating units 20 extend parallel between the longitudinal supports and electrically connect to a common electrical return 16 and a power input 18 located by the frame. The heating units 20 include both a ceramic heater and one or more positive temperature coefficient (PTC) elements. The ceramic heater quickly and directly heats air and helps lower the inrush current of each PTC element upon initial powering. Thus, allowing for higher initial power.

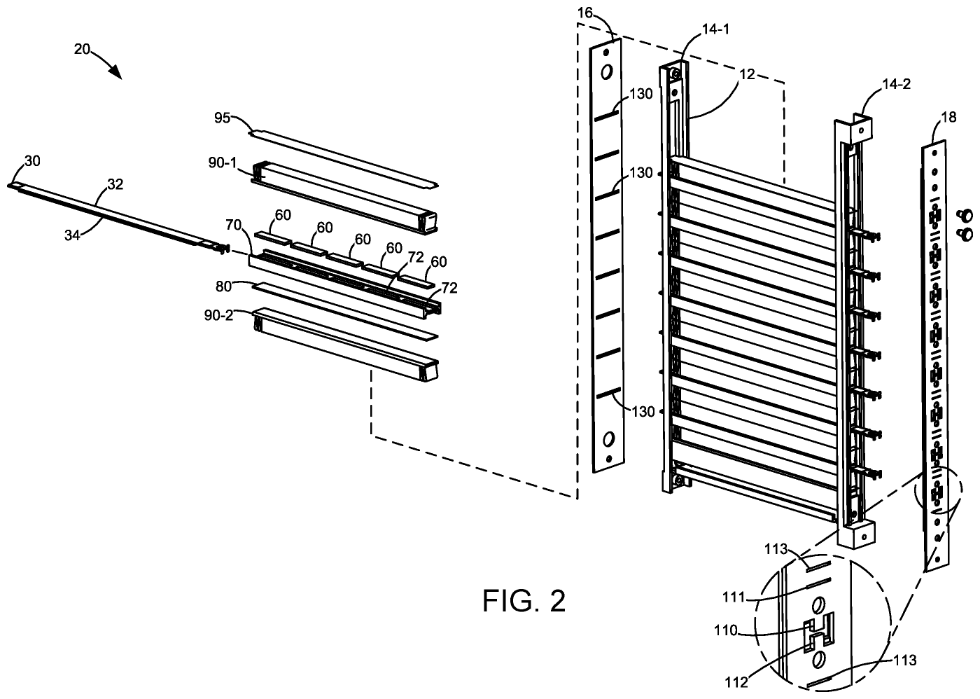

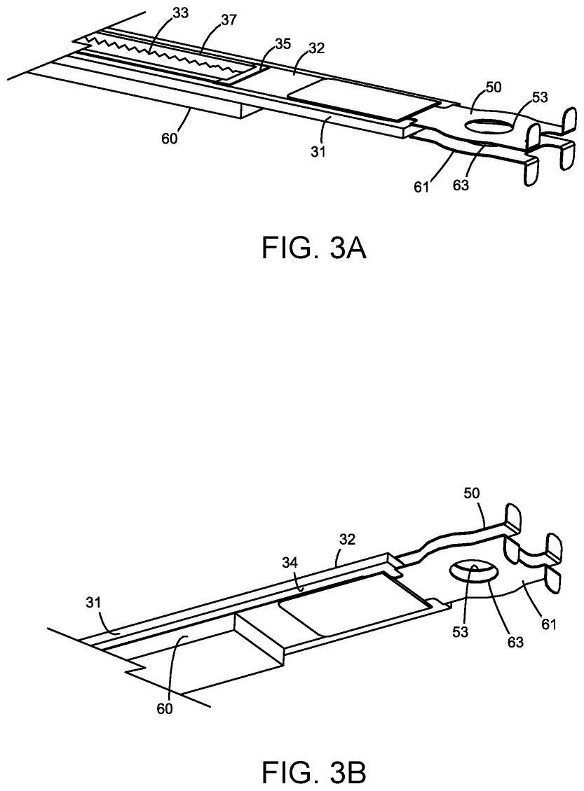

In more detail, FIG. 1B shows a cross section of an individual heating unit as it is arranged in the frame. In FIG. 2, the unit is shown in exploded view. At its core, the ceramic heater 30 is a thick-film printed heater having a longitudinal extent traversing a length of the heating unit. The layers of the heater are noted in FIGS. 3A and 3B. They include a base or substrate 31, such as aluminum nitride, with one or more resistive traces 33 patterned on a topside 32 thereof. A conductor 35 connects the traces to power from an external source. The traces connect with conductive extensions or connectors 50. Their material, such as stainless steel, supports common power voltages in electric vehicles, such as those in ranges from 300-800 Vdc. Similarly, the resistors and conductors are any of a variety, but silver and palladium or platinum mixtures are contemplated. Overlying the traces, and portions of the conductor, is one or more layers of glass 37. On a backside 34 of the base are one or more optional thermistors (not shown). They interconnect with a same or different conductor of the topside. They are positioned to measure the temperature of the heater and the conductor connects the thermistors to external sources to measure, store and control the temperature. The thick-film layers are formed typically with one or more instances of thick-film printing, settling, drying, and firing or heating. As shorthand from the industry, they are generally known as steps of print, dry, and fire, or PDF.

Referring back to FIGS. 1B and 2, the heating unit 20 includes one or more PTC elements 60 in contact with a surface of the topside 32 of the heater 30. In this way, the PTC elements conduct heat from the heater 30 and more quickly heat than they otherwise would in the prior art when a PTC heater has no ceramic heater but only has a series of PTC elements. That PTC materials when cold also have a severely low resistance, thus creating an extremely high inrush current, the heat from the heater 30 limits this inrush current as the heater heats rapidly, especially at high power. The number and arrangement of PTC elements 60 can vary according to needs of vehicle manufacturers allowing for easy customization. A locator 70 has predesigned slots 72 sized and shaped to accommodate the number of PTC elements and can be swapped out according to design.

On an opposite side of the PTC elements, an insulator 80 resides and contacts the each of the PTC elements. The insulator also runs a length of the heating unit. The insulator typifies an aluminum nitride substrate, but may be any of a variety. The insulator exists to improve heat transfer during use. The heat transfer extends between the heater 30 and a pair of heat sinks 90-1, 90-2. The heat sinks serve to enclose the heater 30 and the PTC elements 60 from a top to bottom thereof. A conductive shim 95, such as a highly thermally-conductivity material, e.g., Al, Cu, provides further heat transfer between the heat sinks. A spring bar 100 contacts a top of the shim to provide an appropriate bias to keep in place an entirety of the heating unit 20. When installed in the frame 12, each of the heating units 20 electrically connect to the common electrical return 16 and the power input 18. The ceramic heater 30 and the PTC elements 60 each have an associated conductive extension 50, 61 (FIGS. 3A and 3B) that connects to the power input 18.

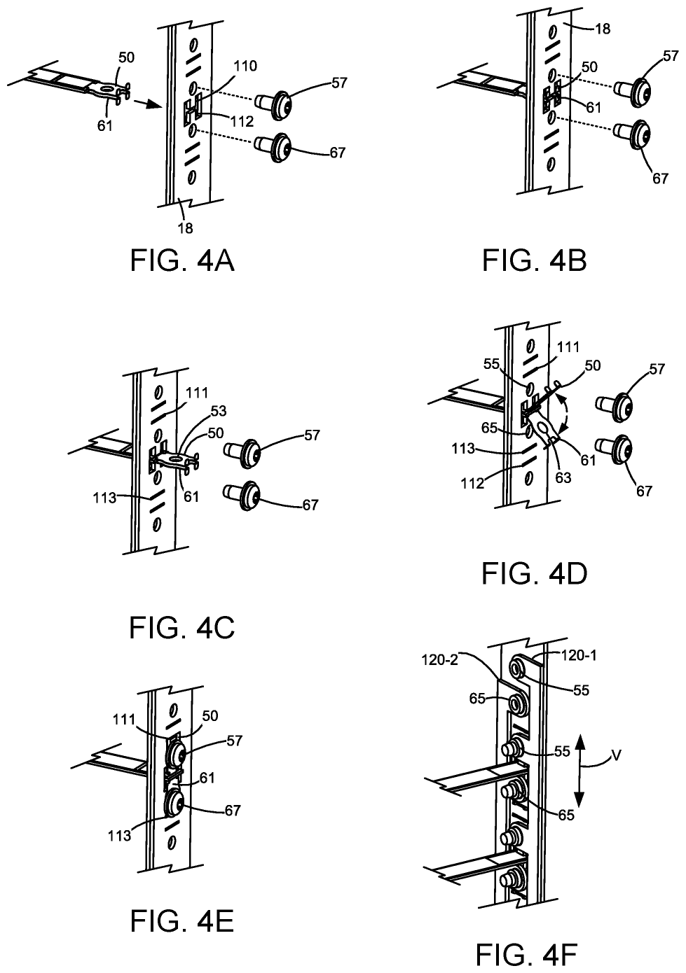

That is, by referencing the sequence depicted in FIGS. 4A-4F, the conductive extensions 50, 61 uniquely pass through an associated slot 110, 112 in the power input 18 and fold into place to connect the heater and PTC elements to power. In FIG. 4A, the conductive extensions 50, 61 are started in a direction (arrow) to pass through the power input 18 as in FIG. 4B. Upon full insertion (FIG. 4C), each of the conductive extensions 50, 61 are folded upward or downward (FIG. 4D) from their straight position and inserted into the power input at 111, 113, respectively. Apertures 53, 63, in the conductive extensions (FIGS. 4C, 4D) mate with associated apertures 55, 65 (FIG. 4D) in the power input 18 whereupon fasteners 57, 67 secure the heater 30 and PTC elements to power (FIG. 4E). The power input 18 also includes a plurality of conductive rails that fasten to either the conductive extension of the ceramic heater or the PTC elements, but not both. As seen in FIG. 4F, the conductive rails 120-1, 120-2 are similarly shaped to one another, but offset vertically (V) in a direction parallel to the longitudinal supports of the frame. This enables each rail to be spaced apart and electrically isolated from one another so as to not short together the heater and the PTC elements. As the rails are also the same piece, this facilitates ease of manufacturing. The rails typify steel, but may be any conductive material.

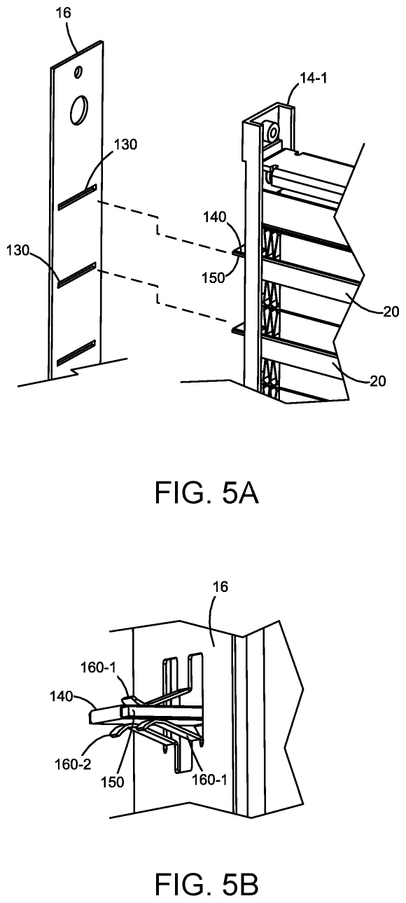

With reference to FIGS. 5A and 5B, each of the heaters and PTC elements of heating units 20 connect to the common electrical return 16. The return has pluralities of slots 130 for receipt of conductive extensions 140, 150 associated with the heater and PTC elements. The extensions are of any material, so long as they are electrically conductive. The extensions also pass through the slots 130, whereupon springs 160-1, 160-2, 160-3 contact and bias in place the extensions 140, 150 of the heating unit 20. That the springs 160 and electrical return 16 are electrically conductive, the heating units are electrically grounded during use when the cabin heater is installed in a vehicle and connected to electrical ground.

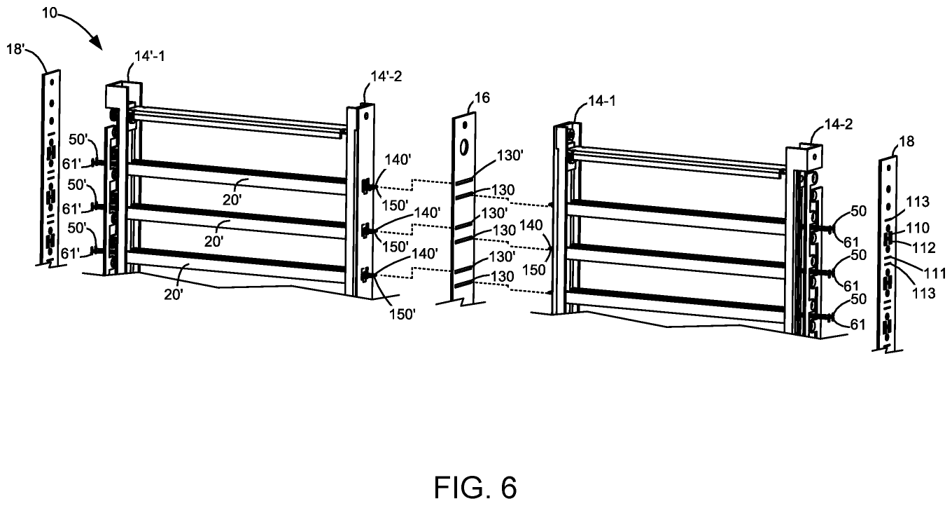

In FIG. 6, the frame 10 of the cabin heater can be expanded adjacently. That is, other spaced apart longitudinal supports 14′-1, 14′-2 are provided to support and locate further pluralities of heating units 20′. Each heating unit in this regard, however, is arranged oppositely the heating units 20 supported by longitudinal supports 14-1, 14-2 so that each has conductive extensions 140′, 150′ and 140, 150 fronting the common electrical return 16. By adding more slots 130′ to the return, all the heating units 120 and 120′ can share and be commonly grounded by a single return. Powering of the heating units 20′ occurs by adding another power input 18′ on an opposite side of the heating units 20′. They also attach by passing conductive extensions 50′, 61′ through the power input 18′ and folding them up or down to connect the heaters and PTC elements to power as described earlier in reference to FIGS. 4A-4F.

Skilled artisans should now recognize features of the invention over the state of the art. Among them, but not exclusively: the current design includes a ceramic heater to provide heating means directly to air and to the PTC elements minimizing the inrush current to the PTC element, thus allowing for higher initial power to more quickly heat air and provide better occupant comfort in cabins in low temperature conditions; the current design provides power to both the ceramic heater and the PTC elements made easy for assembly as power contacts lie flat initially and then fold out into positions to engage respective power terminals after sliding through conductive rails; and the current design implements spring loaded contacts facilitating grounding of the ceramic heater and PTC elements, with the contacts being a combined architecture for both the heater and PTC elements.

The foregoing illustrates various aspects of the invention. It is not intended to be exhaustive. Rather, it is chosen to provide the best mode of the principles of operation and practical application known to the inventor so one skilled in the art can practice it without undue experimentation. All modifications and variations are contemplated within the scope of the invention as determined by the appended claims. Relatively apparent modifications include combining one or more features of one embodiment with those of other embodiments.

1. A heater for a cabin of a vehicle, comprising:
a frame having spaced apart longitudinal supports to locate a common electrical return and a power input;
a ceramic heater; and
at least one positive temperature coefficient (PTC) element contacting a surface of the ceramic heater, each of the ceramic heater and the at least one positive temperature coefficient element extending between the spaced apart longitudinal supports thereby being electrically connected to the common electrical return and the power input.

2. The heater of claim 1, wherein the power input includes a plurality of conductive rails spaced apart and electrically isolated from one another to individually supply power to either the ceramic heater or the at least one PTC element, but not both.

3. The heater of claim 2, wherein each of the ceramic heater and the at least one PTC element have an associated conductive extension that passes through the plurality of conductive rails that can be folded into contact with one of the plurality of conductive rails but not both.

4. The heater of claim 3, wherein each of the plurality of conductive rails includes an aperture for receiving a fastener to tighten into contact with one another either the ceramic heater and a first of the plurality of conductive rails or the at least one PTC element and a second of the plurality of conductive rails upon the conductive extensions of the ceramic heater and the at least one PTC element passing through the plurality of conductive rails.

5. The heater of claim 2, wherein the plurality of conductive rails are substantially similar in shape but offset from one another in a direction parallel to the longitudinal extent of the longitudinal supports.

6. The heater of claim 1, wherein the common electrical return includes a slot whereby a conductive extension of the ceramic heater passes through.

7. The heater of claim 6, wherein a plurality of springs contact and bias the conductive extension upon passing through the slot.

8. The heater of claim 1, further including an Aluminum Nitride insulator contacting the at least one PTC element on a side opposite a side where the ceramic heater contacts the at least one PTC element.

9. The heater of claim 1, further including a locator for receiving the at least one PTC element, the locator for positioning one or more PTC elements to adjust heating potential of the heater.

10. The heater of claim 1, further including two heat sinks to enclose therein from a top and bottom the ceramic heater and the at least one PTC element.

11. The heater of claim 10, further including a conductive shim to assist in heat transfer between the two heat sinks.

12. The heater of claim 1, further including another two spaced apart longitudinal supports adjacent to the spaced apart longitudinal supports thereby sharing the common electrical return and locating another power input, the another two spaced apart longitudinal supports having extending there between another ceramic heater and at least one other PTC element contacting a surface of the another ceramic heater and being electrically connected to the common electrical return and the another power input.

13. A cabin heater for a vehicle, comprising:
a frame having spaced apart longitudinal supports to locate a common electrical return and a power input;
a single ceramic heater; and
a plurality of positive temperature coefficient (PTC) elements contacting a same surface of the single ceramic heater, each of the ceramic heater and the plurality of positive temperature coefficient elements extending parallel between the spaced apart longitudinal supports and being electrically connected to the common electrical return and the power input, the single ceramic heater to lower inrush current of each of the plurality of PTC elements upon initial powering.

14. The cabin heater of claim 13, wherein the power input includes a plurality of conductive rails spaced apart and electrically isolated from one another to individually supply power to either the single ceramic heater or the plurality of PTC elements, but not both.

15. The cabin heater of claim 14, wherein each of the single ceramic heater and the plurality of PTC elements have a conductive extension that passes through the plurality of conductive rails that can be folded into contact with one of the plurality of conductive rails but not both.

16. The cabin heater of claim 15, wherein each the plurality of conductive rails have a same shape but are offset from one another in a direction parallel to the longitudinal extent of the longitudinal supports.

17. The cabin heater of claim 16, wherein said each of the plurality of conductive rails includes an aperture for receiving a fastener to tighten into contact with one another either the single ceramic heater and a first of the plurality of conductive rails or the plurality of PTC elements and a second of the plurality of conductive rails upon the conductive extensions of the ceramic heater and the plurality of PTC elements passing through the plurality of conductive rails.

18. The cabin heater of claim 13, further including two heat sinks to enclose therein as a unit from a top and bottom the single ceramic heater and the plurality of PTC elements.

19. The cabin heater of claim 18, further including a plurality of said units, each having said two heat sinks enclosing therein one ceramic heater and more than one PTC elements in contact with the one ceramic heater.

20. The cabin heater of claim 19, wherein each of the plurality of said units extend parallel between the spaced apart longitudinal supports and electrically connect to the common electrical return and the power input.
